(19) United States
(12) Patent Application Publication
(10) Pub. No.: US 2007/0024930 A1
(43) Pub. Date: Feb. 1, 2007

(54) Scanning methods with light mixing

(75) Inventor: Ming Cai, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION, Sakai (JP)

(21) Appl. No.: 11/492,844

(22) Filed: Jul. 26, 2006

(30) Foreign Application Priority Data
Jul. 28, 2005 (TW) 94125610

(51) Int. Cl. H04N 1/46

(52) U.S. Cl. 358/509

(57) ABSTRACT

Scanning methods with light mixing are provided. A scanning method with light mixing includes the steps of providing a scan target and a scanner, wherein the scanner comprises three light sources of different colors, disposing the scan target on the scanner, selecting two light sources from the three light sources, turning on the two selected light sources simultaneously to form a mixed light source, illuminating the scan target by the mixed light source, and scanning the scan target to generate an image signal.

### BACKGROUND

The invention relates to scanning methods with light mixing.

Conventionally, in a scanner with contact image sensor (CIS), a scan target is illuminated by three light sources of red (R), green (G), and blue (B) respectively and then scanned by a contact image sensor (CIS) to generate a scan image having RGB color information.

When the scan target, such as a document, needs to be printed, the scan image must be transformed from RBG format to CMY format (cyan (C), magenta (M), and yellow (Y)), to be compatible with printer specification, thus potentially causing loss of color information and waste of time.

### SUMMARY

Scanning methods with light mixing are provided.

An embodiment of a scanning method with light mixing includes the steps of providing a scan target and a scanner comprising three light sources of different colors, disposing the scan target on the scanner, selecting two from the three light sources, turning on the two selected light sources simultaneously to form a mixed light source, illuminating the scan target by the mixed light source, and scanning the scan target to generate an image signal.

Some embodiments of a scanning method with light mixing include the steps of providing a scan target and a scanner comprising a first, a second, and a third light sources of different colors, disposing the scan target on the scanner, turning on the first and second light sources simultaneously to form a first mixed light source, and illuminating the scan target by the first mixed light source and scanning the scan target to generate a first image signal.

Some embodiments of a scanning method with light mixing include the steps of providing a scan target and a scanner comprising three light sources of different colors, disposing the scan target on the scanner, determining an output mode of the scanner, and if the output mode is “PREVIEW”, turning on the three light sources to illuminate the scan target sequentially and scanning the scan target to generate a first scan image, and if the output mode is “PRINT”, turning on two of the three light sources sequentially to form three mixed light sources, illuminating the scan target by the three mixed light sources sequentially, and scanning the scan target to generate a second scan image.

### DESCRIPTION OF THE DRAWINGS

The invention can be more fully understood by reading the subsequent detailed description and examples with references made to the accompanying drawings, wherein:

FIG. 1 is a schematic diagram of an embodiment of a scanner;

FIG. 2 is a flowchart of an embodiment of a scanning method with light mixing;

FIG. 3 is a schematic diagram of another embodiment of a scanner, wherein the scanner is connected to a printer in a computer system;

FIG. 4 is a flowchart of another embodiment of a scanning method with light mixing;

FIG. 5 is a schematic diagram of another embodiment of a scanner, wherein the scanner is connected to a printer and a display in a computer system; and

FIG. 6 is a flowchart of another embodiment of a scanning method with light mixing.

### DETAILED DESCRIPTION

The invention provides a method of generating a scan image having CMY color information, in addition to a scan image having RGBcolor information, by forming three mixed light sources by turning on two of the three light sources sequentially and illuminating a scan target by the three mixed light sources sequentially. To preview the scan target, the scanner outputs the scan image having RGB color information. To print the scan target, the scanner outputs the scan image having CMY color information.

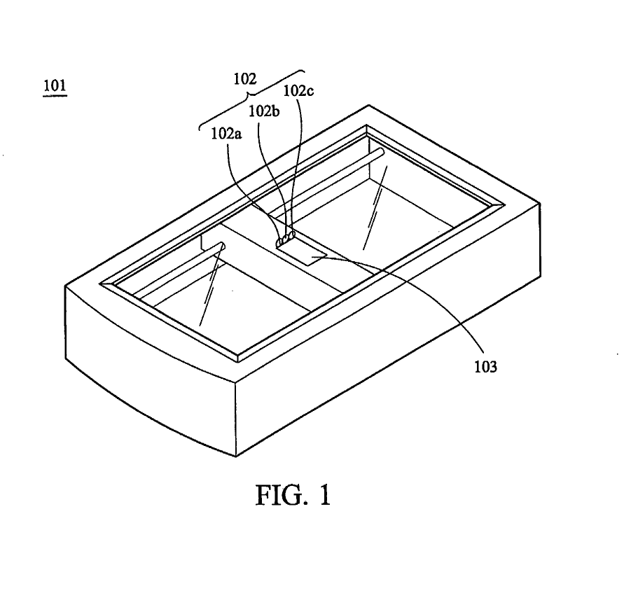

FIG. 1 is a schematic diagram of an embodiment of a scanner 101.

The scanner 101 includes three light sources 102 of different colors and an image capture unit 103.

The three light sources 102 are a red light source 102a, a green light source 102b, and a blue light source 102c respectively.

The image capture unit 103 is a contact image sensor (CIS), scanning a scan target disposed on the scanner 101.

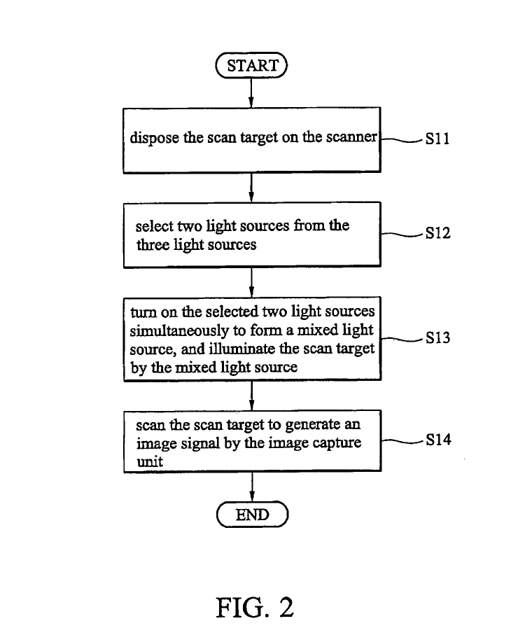

FIG. 2 is a flowchart of an embodiment of a scanning method with light mixing.

First, in step S11, the scan target is disposed on the scanner 101.

In step S12, two light sources are selected from the three light sources 102 according to requirements. In this embodiment, the red light source 102a and the green light source 102b are selected.

In step S13, the two selected light sources are turned on simultaneously to form a mixed light source. In this embodiment, the mixed light source formed by turning on the red light source 102a and the green light source 102b simultaneously is a yellow light source. Additionally, in this step, the scan target is illuminated by the mixed light source.

Finally, in step S14, the image capture unit 103 scans the scan target to generate an image signal.

In this embodiment, the image signal generated is an image signal from which yellow color is filtered out.

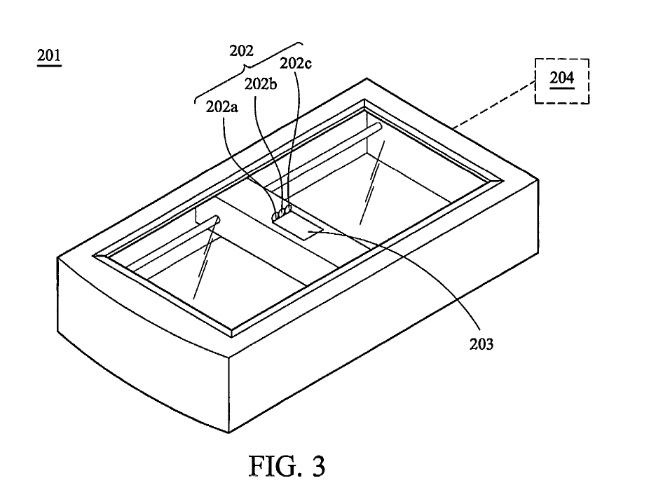

FIG. 3 is a schematic diagram of another embodiment of a scanner 201, wherein the scanner 201 is connected to a printer 204 in a computer system.

The scanner 201 includes three light sources 202 of different colors and an image capture unit 103. The scanner 201 is connected to the printer 204 in the computer system.

The three light sources 202 are a first light source 202a, a second light source 202b, and a third light source 202c respectively. In this embodiment, the first light source 202a is red, the second light source 202b is green, and the third light source 202c is blue.

The image capture unit 203 is a contact image sensor (CIS), scanning a scan target disposed on the scanner 201.

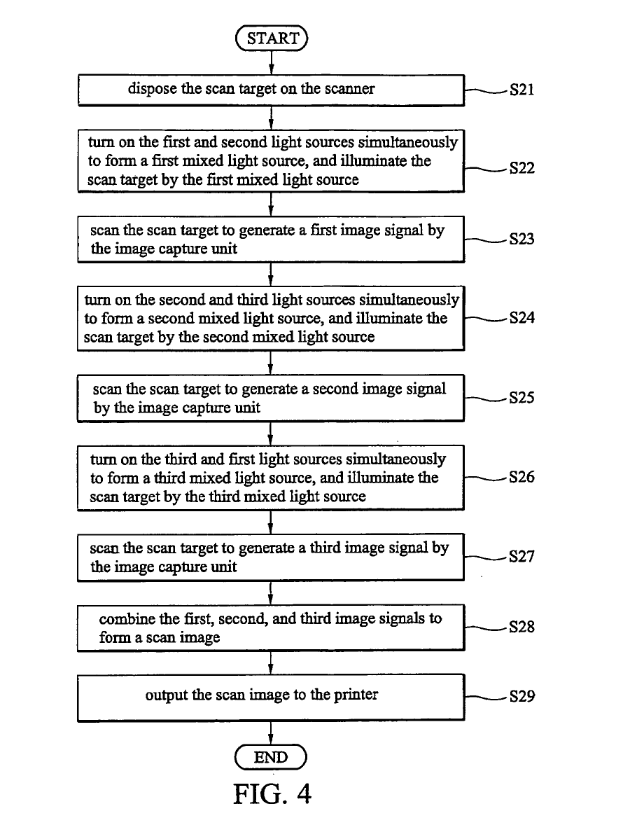

FIG. 4 is a flowchart of another embodiment of a scanning method with light mixing.

First, in step S21, the scan target is disposed on the scanner 201.

In step S22, the first light source 202a and the second light source 202b are turned on simultaneously to form a first mixed light source. In this embodiment, the first mixed light source formed by turning on the red light source 202a and the green light source 202b simultaneously is a yellow light source. Additionally, in this step, the scan target is illuminated by the first mixed light source.

In step S23, the image capture unit 203 scans the scan target to generate a first image signal.

In step S24, the second light source 202b and the third light source 202c are turned on simultaneously to form a second mixed light source. In this embodiment, the second mixed light source formed by turning on the green light source 202b and the blue light source 202c simultaneously is a cyan light source. Additionally, in this step, the scan target is illuminated by the second mixed light source.

In step S25, the image capture unit 203 scans the scan target to generate a second image signal.

In step S26, the third light source 202c and the first light source 202a are turned on simultaneously to form a third mixed light source. In this embodiment, the third mixed light source formed by turning on the blue light source 202c and the red light source 202a simultaneously is a magenta light source. Additionally, in this step, the scan target is illuminated by the third mixed light source.

In step S27, the image capture unit 203 scans the scan target to generate a third image signal.

In step S28, the first, the second, and the third image signals are combined to form a scan image having CMY color information, i.e. cyan, magenta, yellow color information.

Finally, in step S29, the scan image is output to the printer 204 directly.

It is noted that because the printer 204 can process a CMY image directly, the scan image can be input to the printer 204 directly without any transformation or processing.

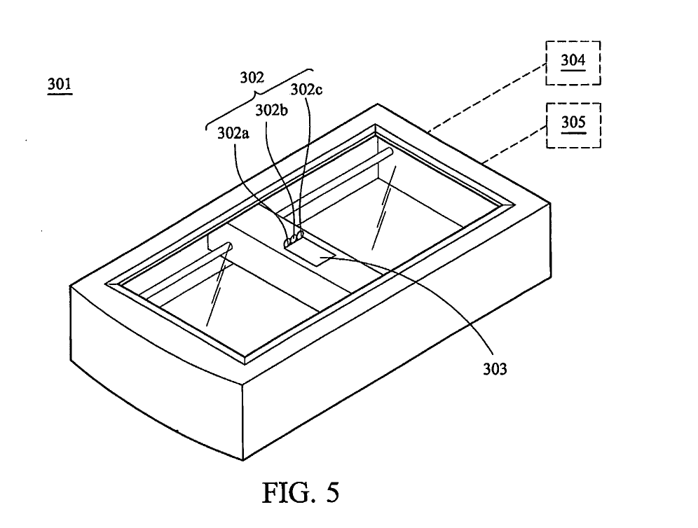

FIG. 5 is a schematic diagram of another embodiment of a scanner 301, wherein the scanner 301 is connected to a printer 304 and a display 305 in a computer system.

The scanner 301 includes three light sources 302 of different colors and an image capture unit 303. The scanner 301 is connected to the printer 304 and the display 305 in the computer system.

The three light sources 302 are a red light source 302a, a green light source 302b, and a blue light source 302c respectively.

The image capture unit 303 is a contact image sensor (CIS), scanning a scan target disposed on the scanner 301.

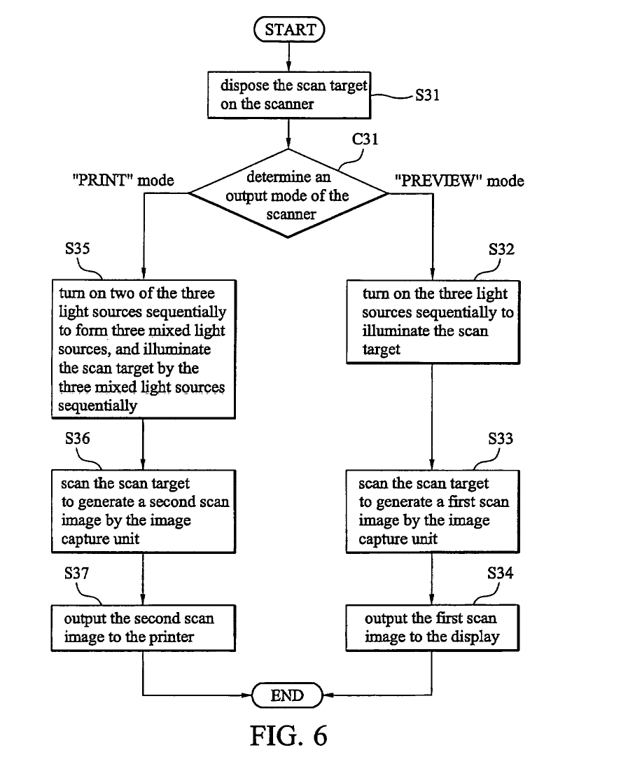

FIG. 6 is a flowchart of another embodiment of a scanning method with light mixing.

First, in step S31, the scan target is disposed on the scanner 301.

In conditional step C31, an output mode of the scanner 301 is determined.

If the output mode is “PREVIEW”, the process goes to step S32. In step S32, the three light sources 302a, 302b, 302c are turned on sequentially to illuminate the scan target.

Next, in step S33, the image capture unit 303 scans the scan target to generate a first scan image.

Finally, in step S34, the first scan image is output to the display 305 after which the process stops.

If the output mode is “PRINT”, the process goes to step S35. In step S35, two of the three light sources 302a, 302b, 302c are turned on sequentially to form three mixed light sources. In this embodiment, the three mixed light sources formed are yellow, cyan, and magenta light sources respectively. Additionally, in this step, the scan target is illuminated by the three mixed light sources sequentially.

Next, in step S36, the image capture unit 303 scans the scan target to generate a second scan image.

Finally, in step S37, the second scan image is output to the printer 304 after which the process stops.

Some embodiments of a scanning method with light mixing can generate a scan image having CMY color information, in addition to a scan image having RGB color information, by forming three mixed light sources by turning on two of the three light sources sequentially and illuminating a scan target by the three mixed light sources sequentially.

To preview the scan target, the scanner outputs the scan image having RGB color information, and to print the scan target, the scanner outputs the scan image having CMY color information, thus avoiding loss of color information and waste of time due to color format transformation.

While the invention has been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanning method with light mixing, comprising the steps of:
providing a scan target and a scanner, wherein the scanner comprises three light sources of different colors;
disposing the scan target on the scanner;
selecting two light sources from the three light sources;
turning on the two selected light sources simultaneously to form a mixed light source;
illuminating the scan target by the mixed light source; and
scanning the scan target to generate an image signal.

2. The scanning method as claimed in claim 1, wherein the three light sources are red, green, and blue respectively.

3. The scanning method as claimed in claim 1, wherein the scanner further comprises an image capture unit, and the step of scanning the scan target to generate an image signal is scanning the scan target by the image capture unit to generate the image signal.

4. The scanning method as claimed in claim 3, wherein the image capture unit is a contact image sensor (CIS).

5. A scanning method with light mixing, comprising the steps of:
providing a scan target and a scanner, wherein the scanner comprises a first, a second, and a third light sources of different colors;
disposing the scan target on the scanner;
turning on the first and the second light sources simultaneously to form a first mixed light source; and
illuminating the scan target by the first mixed light source and scanning the scan target to generate a first image signal.

6. The scanning method as claimed in claim 5, wherein the first light source is red, the second light source is green, the third light source is blue, and the first mixed light source is yellow.

7. The scanning method as claimed in claim 5, wherein the scanner further comprises an image capture unit, and the step of illuminating the scan target by the first mixed light source and scanning the scan target to generate a first image signal is illuminating the scan target by the first mixed light source and scanning the scan target by the image capture unit to generate the first image signal.

8. The scanning method as claimed in claim 7, wherein the image capture unit is a contact image sensor (CIS).

9. The scanning method as claimed in claim 5, further comprising the steps of:
turning on the second and the third light sources simultaneously to form a second mixed light source;
illuminating the scan target by the second mixed light source and scanning the scan target to generate a second image signal;
turning on the third and the first light sources simultaneously to form a third mixed light source; and
illuminating the scan target by the third mixed light source and scanning the scan target to generate a third image signal.

10. The scanning method as claimed in claim 9, wherein the first light source is red, the second light source is green, the third light source is blue, the first mixed light source is yellow, the second mixed light source is cyan, and the third mixed light source is magenta.

11. The scanning method as claimed in claim 9, further comprising the steps of:
combining the first, the second, and the third image signals to form a scan image; and
outputting the scan image.

12. The scanning method as claimed in claim 11 further comprising a step of providing a printer, wherein the step of outputting the scan image is outputting the scan image to the printer.

13. A scanning method with light mixing, comprising the steps of:
providing a scan target and a scanner, wherein the scanner comprises three light sources of different colors;
disposing the scan target on the scanner;
determining an output mode of the scanner;
if the output mode is “PREVIEW”, turning on the three light sources to illuminate the scan target sequentially and scanning the scan target to generate a first scan image; and
if the output mode is “PRINT”, turning on two of the three light sources sequentially to form three mixed light sources, and scanning the scan target to generate a second scan image.

14. The scanning method as claimed in claim 13, wherein the three light sources are red, green, and blue respectively, and the three mixed light sources are yellow, cyan, and magenta.

15. The scanning method as claimed in claim 14 further comprising a step of providing a display and a printer, wherein the step of if the output mode is “PREVIEW” further comprises a step of outputting the first scan image to the display, and the step of if the output mode is “PRINT” further comprises a step of outputting the second scan image to the printer.
